(19) United States
(12) Patent Application Publication
(10) Pub. No.: US 2026/0158713 A1
(43) Pub. Date: Jun. 11, 2026

(54) CHANNEL FORMING MEMBER AND METHOD FOR MANUFACTURING CHANNEL FORMING MEMBER

(71) Applicant: CANON KABUSHIKI KAISHA, Tokyo (JP)

(72) Inventors: YASUAKI KITAYAMA, Kanagawa (JP); TATSUKI SASAKI, Kanagawa (JP)

(21) Appl. No.: 19/386,427

(22) Filed: Nov. 12, 2025

(30) Foreign Application Priority Data
Dec. 5, 2024 (JP) 2024-212542

(51) Int. Cl. B29C 45/00; B29C 45/38; B29L 31/00

(52) U.S. Cl. CPC B29C 45/0062; B29C 45/38; B29C 2045/0063; B29L 2031/767

(57) ABSTRACT

A method for manufacturing a channel forming member includes pouring melt resin around an abutting portion between a first constituent part and a second constituent part. In the pouring melt resin, the melt resin forms a bonding portion and a thickened portion, the bonding portion abuts the first constituent part and the second constituent part, the thickened portion abuts only one of the first constituent part and the second constituent part or abuts neither the first constituent part nor the second constituent part, and the volume of the thickened portion is more than or equal to 50% of the volume of the bonding portion.

### BACKGROUND

### Field of the Technology

The present disclosure relates to a channel forming member and a method for manufacturing a channel forming member.

### Description of the Related Art

Liquid ejection heads are known for ejecting liquids, such as ink, onto a print medium. Examples of liquid ejection heads include an inkjet print head capable of ejecting a liquid such as ink supplied from a liquid container such as an ink tank from a plurality of ejection ports. A liquid ejection head capable of ejecting a plurality of types of inks includes a channel forming member having a plurality of liquid supply paths formed therein corresponding to each ink. Such a channel forming member having the liquid supply paths is typically formed by assembling a plurality of parts injection-molded from resin materials, due to its ease of manufacture, light weight, and corrosion resistance. For example, a plurality of parts are individually injection-molded and then assembled by ultrasonic welding, bonding with an adhesive agent, or the like.

A technology has recently emerged to simplify this manufacturing method, by simultaneously molding a plurality of parts within a mold and completing the assembly. Japanese Patent Laid-Open No. 2001-347536 (hereinafter referred to as Document 1) describes a manufacturing method using die slide injection (hereinafter referred to as DSI) molding, which enables a plurality of parts to be injection-molded and joined within the same mold. Japanese Patent Laid-Open No. 2019-142013 (hereinafter referred to as Document 2) describes a manufacturing method using die rotary injection (hereinafter referred to as DRI) molding, which enables a plurality of parts to be injection-molded and joined within the same mold.

In a manufacturing method for molding and assembling a plurality of resin molded parts within the same mold, there is a demand for increased options for a molding machine.

### SUMMARY

A manufacturing method according to an aspect of the present disclosure is a method for manufacturing a channel forming member in which a fluid channel is formed between a first constituent part and a second constituent part, including: injection-molding the first constituent part at a first position between a pair of molds and injection-molding the second constituent part at a second position between the pair of molds; opening the pair of molds so that the first constituent part remains in one of the pair of molds and the second constituent part remains in the other of the pair of molds, and then moving the pair of molds relative to each other so that the first constituent part and the second constituent part face each other; closing the pair of molds so that the first constituent part and the second constituent part abut each other; and pouring melt resin around an abutting portion between the first constituent part and the second constituent part, wherein, in the pouring melt resin, the melt resin forms a bonding portion and a thickened portion, the bonding portion abuts the first constituent part and the second constituent part, the thickened portion abuts only one of the first constituent part and the second constituent part, or abuts neither the first constituent part nor the second constituent part, and a volume of the thickened portion is more than or equal to 50% of a volume of the bonding portion.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are respectively a perspective view of a print head including a channel forming member;

FIG. 2 is a diagram showing an example of a method for manufacturing a joint member;

FIG. 3 is a schematic cross-sectional view illustrating molds and an operation of molded parts;

FIG. 4 is a schematic cross-sectional view illustrating the molds and the operation of the molded parts;

FIG. 5 is a schematic cross-sectional view illustrating the molds and the operation of the molded parts;

FIG. 6 is a schematic cross-sectional view illustrating the molds and the operation of the molded parts;

FIG. 7 is a schematic cross-sectional view illustrating the molds and the operation of the molded parts;

FIG. 8 is a schematic cross-sectional view illustrating the molds and the operation of the molded parts;

FIG. 9 is a schematic cross-sectional view illustrating the molds and the operation of the molded parts;

FIG. 10 is a schematic cross-sectional view illustrating the molds and the operation of the molded parts;

FIGS. 11A and 11B are respectively a perspective view and an exploded perspective view of a joint member;

FIGS. 12A and 12B are respectively a perspective view and an exploded perspective view of a joint member;

FIG. 13 is a perspective view of a joint member;

FIG. 14 is a diagram showing a joint member as a comparative example;

FIGS. 15A and 15B are respectively a perspective view and an exploded perspective view of a joint member;

FIGS. 16A and 16B are respectively a perspective view and an exploded perspective view of a joint member;

FIG. 17 is a diagram showing an example of a bonding resin;

FIGS. 18A and 18B are respectively a perspective view and an exploded perspective view of a joint member; and

FIGS. 19A and 19B are respectively a perspective view and an exploded perspective view of a joint member.

### DESCRIPTION OF THE EMBODIMENTS

Preferred embodiments of the present disclosure will be described in detail below with reference to the accompanying drawings. Note that the following embodiments do not limit the scope of the present disclosure, and not all combinations of features described in the following embodiments are necessarily essential to the solution of the present disclosure. Note that the same components will be denoted by the same reference numerals.

### First Embodiment

### <Overview>

Prior to describing this embodiment, DSI molding and DRI molding will be described as methods for manufacturing a hollow body having a hollow portion inside. As described above, these methods enable a plurality of parts to be injection-molded and joined within the same mold. DSI molding involves sliding the mold, while DRI molding involves rotating the mold.

In such a manufacturing method, two parts constituting the hollow body are simultaneously molded (primary molding) at different positions within a pair of molds (a fixed mold and a movable mold), and then the molds are opened. As for these two parts, for example, one is a first part with an opening, and the other is a second part sized and shaped to cover the opening. Upon opening the molds, one of the two parts remains in the fixed mold, and the other remains in the movable mold. Next, one or both of the molds are moved so that the part remaining in the fixed mold faces the other part remaining in the movable mold, and the molds are then closed. In this event, the two parts abut to form a hollow body, but are not bonded together. Then, a melt bonding resin (also called a melt resin) is poured around the abutment portion (secondary molding) to bond the parts together and form the hollow body. One of the advantages of this manufacturing method is that molding and bonding a plurality of parts within the same mold makes it possible to reduce the bonding accuracy of the plurality of parts to the dimensions of a single part. This manufacturing method also enables even a channel forming member of a liquid ejection head to be molded and assembled in the same mold.

In this manufacturing method, the volume of the bonding resin required to seal the bonding portion is typically smaller than the volume of the primary molded part constituting most of the part shape. However, an injection molding machine has a recommended injection volume for stable molding. If there is a large difference in volume between the primary molded part and the bonding resin, or if the volume of the bonding resin is small, the injection volume may not fall within the recommended range. The molds used in this manufacturing method tend to be larger and heavier than standard molds (leading to larger molding machine), while components of a liquid ejection head such as an inkjet print head are often small. For this reason, components mounted on the liquid ejection head are particularly prone to falling below the lower limit of the molding machine's recommended injection volume. On the other hand, simply increasing the injection volume of the bonding resin results in the consumption of resin unnecessary for component functions as the bonding resin, resulting in disadvantages such as increased component size and weight, and the additional post-processing required to remove excess material molded outside the components. Another factor leading to such a problem is that many molding shops do not purchase new molding machines for each product, but rather transfer molds to existing molding machines for molding. This problem also arises in a case where a plurality of injection units are attached to a single mold.

The following embodiment describes a channel forming member and a manufacturing method thereof that can increase the volume of the bonding resin while minimizing the volume difference with the primary molded part. An example of how this can increase options for the molding machine will be described. The channel forming member described below is an application example of a liquid supply member provided in an inkjet print head as an example of a liquid ejection head.

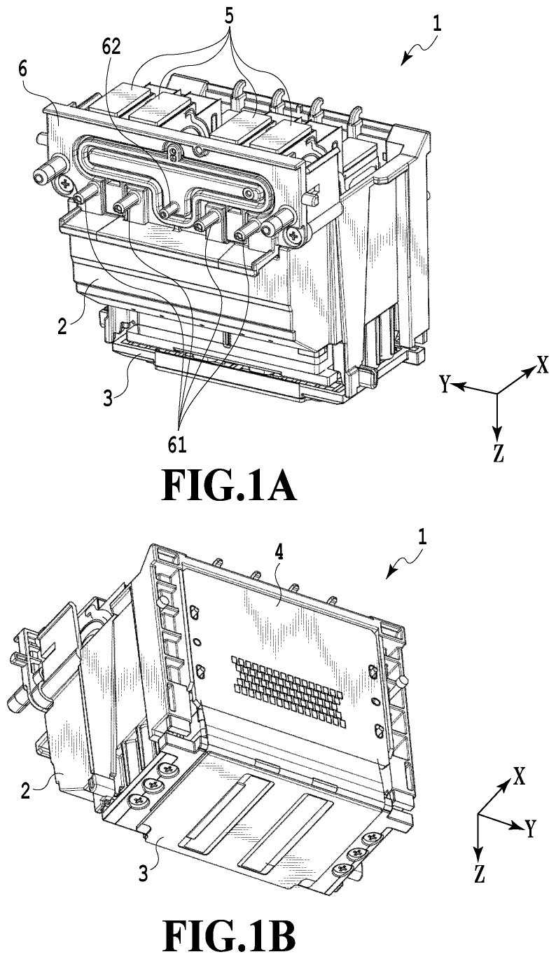

FIGS. 1A and 1B are respectively a perspective view of a print head 1 including a channel forming member (liquid supply member) according to this embodiment. FIGS. 1A and 1B are perspective views of the print head 1 viewed from different directions. The print head 1 according to this embodiment is mounted on a carriage of a so-called serial scan inkjet printing apparatus (liquid ejection apparatus). The print head 1 may also be mounted on a so-called full-line inkjet printing apparatus.

The print head 1 includes a housing member 2, a print element unit 3, an electrical connection board 4, a sub-tank unit 5, and a joint member 6. In this embodiment, the channel forming member corresponds to the joint member 6.

Ink (liquid) is supplied from an unillustrated ink tank (liquid container) to the sub-tank unit 5 through a main body side ink connection needle 61 provided in the joint member 6. The sub-tank unit 5, the housing member 2, and the print element unit 3 are fluidically connected to form a circulating ink channel. The print element unit 3 has a plurality of ejection ports for ejecting ink, which are arranged to form unillustrated ejection port arrays. Each ejection port is provided with an ejection energy generating element such as an electrothermal conversion element (heater) or piezoelectric element. In this example, four colors of inks are supplied to the print head 1, and the four colors of inks are ejected from the ejection port arrays provided corresponding thereto, respectively.

The ejection energy generating elements are driven through the electrical connection board 4 under the control of an unillustrated apparatus main body unit, thereby ejecting the ink from the ejection ports corresponding to the driven ejection energy generating element. The inkjet printing apparatus of this embodiment also includes a deaeration system to periodically remove gas from a liquid chamber of the sub-tank unit 5. A channel for deaeration connects the sub-tank unit 5 to a pressure-reducing mechanism (not illustrated) of the apparatus main body unit via a main body side air connection needle 62 provided in the joint member 6.

As described above, the joint member 6 includes a liquid channel and an air channel, but is not limited to this example. Alternatively, the joint member 6 may include either one of the liquid channel and the air channel. The liquid channel and the air channel are also collectively referred to as a fluid channel.

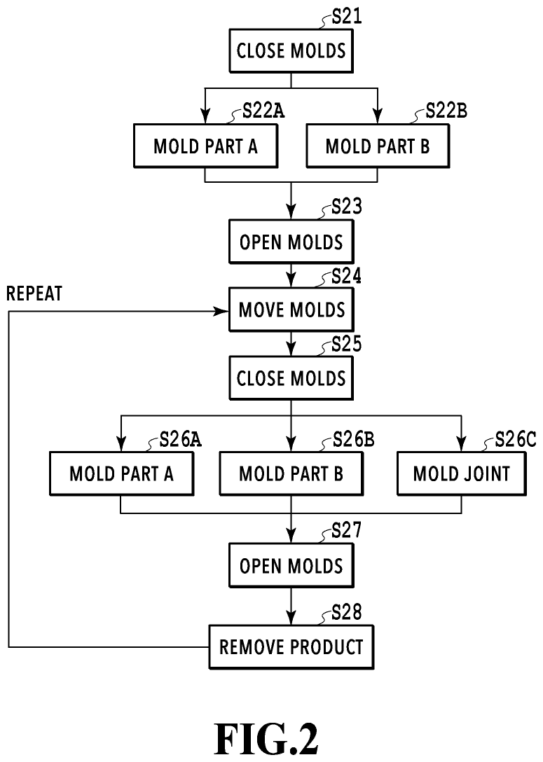

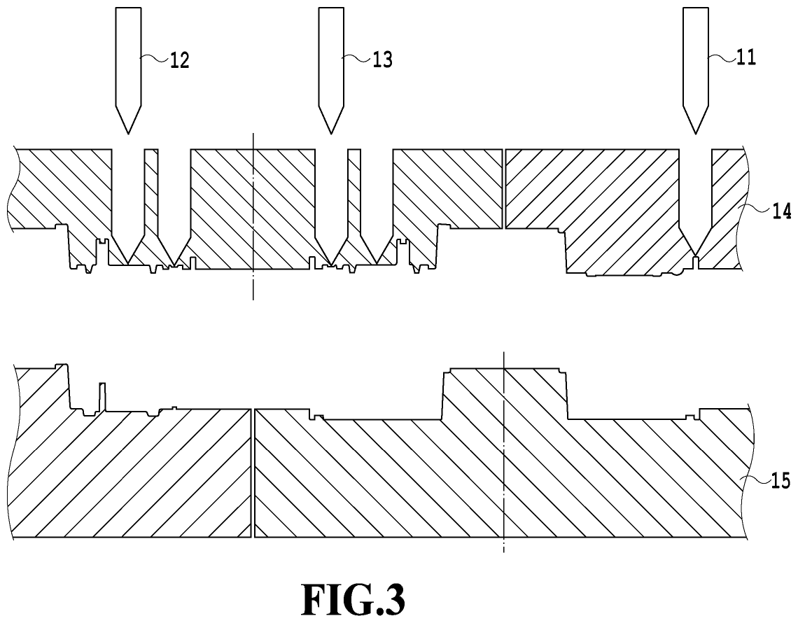

FIG. 2 is a diagram showing an example of a manufacturing method (molding flow) for manufacturing the joint member 6 in this embodiment. FIGS. 3 to 10 are schematic cross-sectional views illustrating molds and operations of molded parts. The method for manufacturing the joint member 6 will be described with reference to FIGS. 2 to 10. In the example shown in FIGS. 3 to 10, the above-mentioned die rotary injection (DRI) molding is used as the manufacturing method. Note that the die slide injection (DSI) molding may also be used.

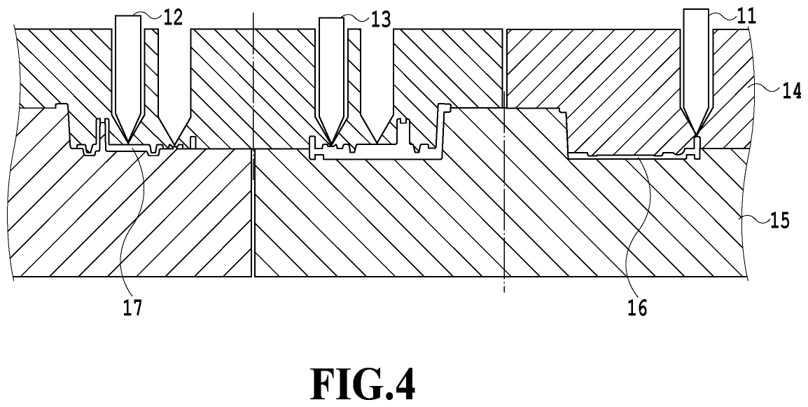

FIG. 3 is a schematic cross-sectional view showing a mold open state before molding. A manufacturing apparatus includes gate valves: a first gate valve 11, a second gate valve 12, and a third gate valve 13. The manufacturing apparatus also includes a pair of molds: a fixed mold 14 and a movable mold 15. The hatching difference of the fixed mold 14 in FIG. 3 distinguishes between rotating and non-rotating sections, as described below. The vertical dotted line indicates the rotation axis. The same applies to the hatching difference and vertical dotted line for the movable mold 15 (the same applies to FIGS. 4 to 10).

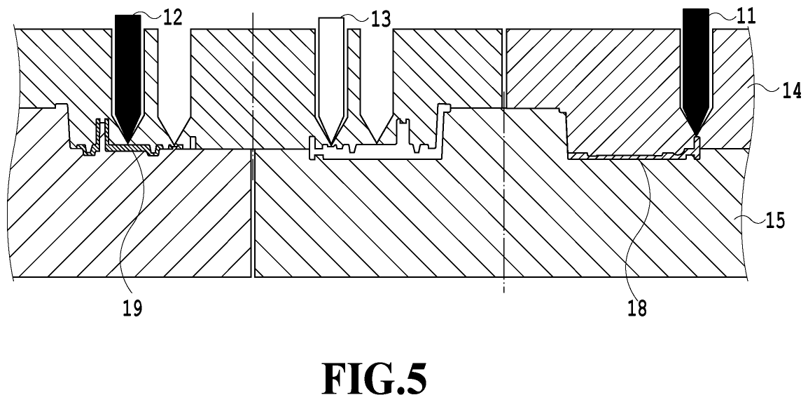

In the mold open state before molding, the gate valves 11, 12, and 13, the fixed mold 14, and the movable mold 15 are separated. Closing the molds from this state (S21) results in a state of FIG. 4. In the state of FIG. 4, the gate valves 11, 12, and 13, the fixed mold 14, and the movable mold 15 abut to form cavities 16 and 17 that define a product shape. Subsequently, as shown in FIG. 5, melt resin is injected through the gate valves 11 and 12 to mold a primary molded part A (18) and a primary molded part B (19) (S22A and S22B). The cavity 16 corresponds to a first position between the pair of molds, and the cavity 17 corresponds to a second position between the pair of molds. While the example is shown where the movable mold 15 moves relative to the fixed mold 14, at least one of the molds may move relative to the other, or both molds may also be configured to move.

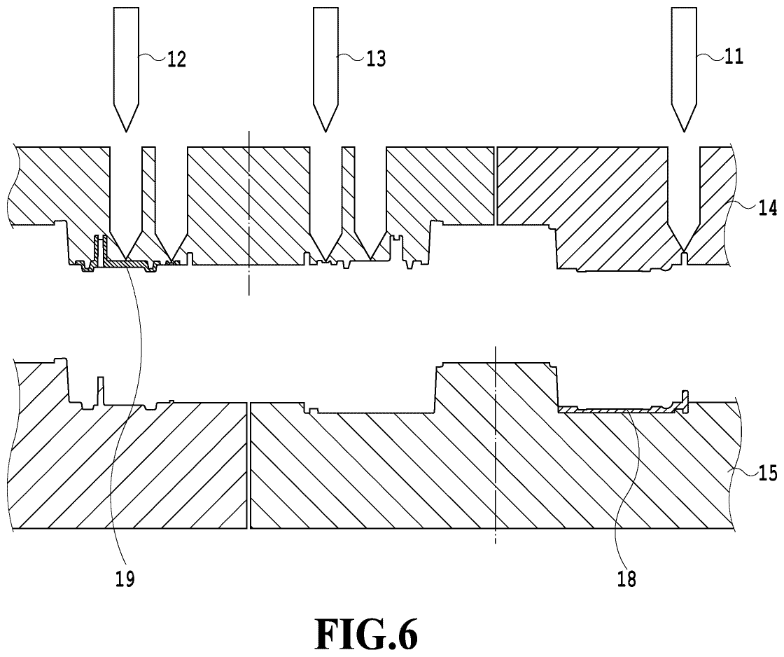

After the primary molded parts are molded, the molds are opened again (S23) as shown in FIG. 6. In this example, the primary molded part B (19) molded in S22B is held by the fixed mold 14, and the primary molded part A (18) molded in S22A is held by the movable mold 15.

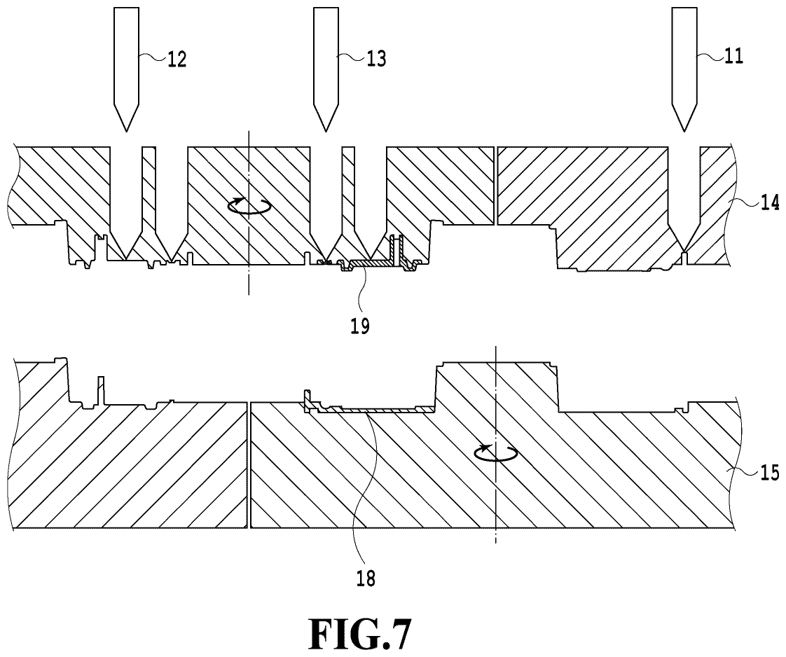

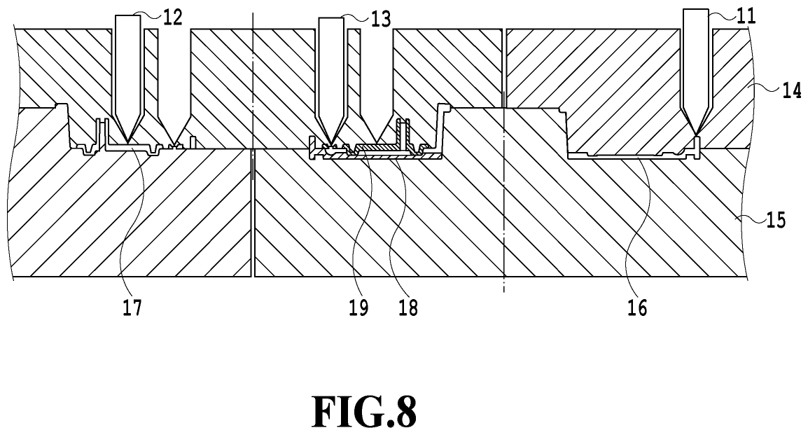

Next, the fixed mold 14 and the movable mold 15 holding the molded parts rotate and move to a position where the primary molded parts 18 and 19 are set in a desired abutment state (S24). FIG. 7 shows a state of the molds moved from the state of FIG. 6. After the molds are moved, the molds are closed again (S25). FIG. 8 shows a state of the molds closed after FIG. 7. In the state of FIG. 8, the primary molded parts 18 and 19 abut against each other to form a joint channel shape and a hollow shape. At the same time, the cavities 16 and 17 that form the primary molded part shapes are also formed again.

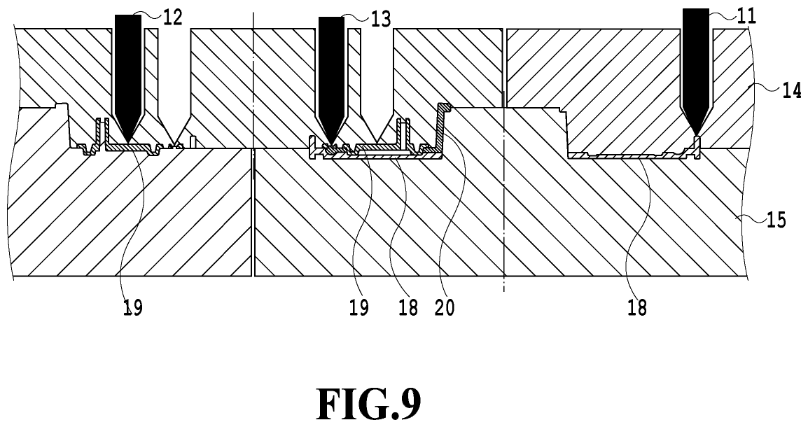

Next, as shown in FIG. 9, melt resin is injected through the gate valves 11, 12, and 13 to mold primary molded parts (S26A and S26B) and perform joint molding (secondary molding) (S26C). The filling timing for the molding in S26A to S26C may be simultaneous, or a specific filling order may be set.

For the joint member 6 of this embodiment, an injection device mounted on the injection molding machine main body is used for primary molding and a compact external injection device is used for secondary molding. A method using these two injection devices to simultaneously perform the primary molding and the secondary molding is adopted. This method using the two injection devices to simultaneously perform the primary molding and the secondary molding makes it possible to set the same molding conditions for secondary molded parts as for the regular molding, even in DSI or DRI molding, without extending the molding time. Another advantage is that the primary molding and the secondary molding can be performed using different materials. While the compact external injection device used in this example is a type attached to the mold, the injection device may also be of a type attached to the injection molding machine main body.

Another molding method involves adjusting the gate opening and closing timing during a single molding operation. Specifically, the primary molded parts A (18) and B (19) are filled simultaneously, and after closing the primary molding gate valve during a pressure keeping process, the secondary molding gate valve 13 is opened to fill a bonding resin 20. In other words, for the secondary molding, the filling is performed only during the pressure keeping process of the molding machine. During the pressure keeping process, the filling is performed to maintain a constant pressure. This has the advantage of reducing challenges unique to DSI molding and DRI molding, such as excessive injection pressure causing deformation of the primary molded parts (that is, collapse of the secondary resin path), which can lead to secondary resin inflow (resin leakage) into hollow portions (ink channel, air channel, and the like). However, because this filling method does not involve active flowing of the resin like the injection speed-prioritized filling used in typical molding, the filling takes time, leading to a possibility of solidifying the melt resin. While each molding method has its advantages and disadvantages, the joint member 6 of this embodiment may be molded using any molding method.

Note that the joint member 6 of this embodiment uses the same filler-containing material for all of the primary molded parts A (18) and B (19) and the bonding resin, but it is also not a problem to manufacture the joint member 6 using a plurality of materials. However, the primary molded parts and the bonding resin may be made of compatible materials.

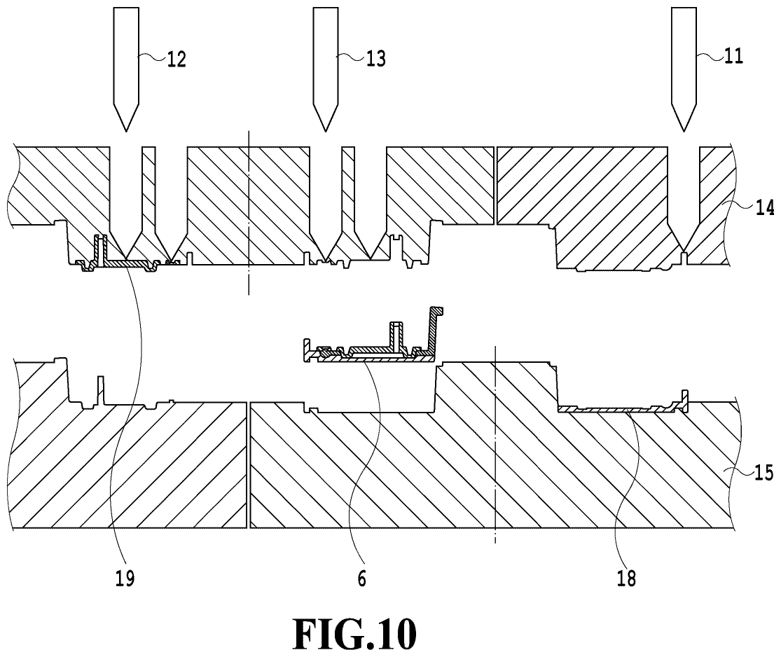

After bonding is complete, the molds are opened again as shown in FIG. 10 (S27). Then, as shown in FIG. 10, the completed molded product (joint member 6) is removed (S28). After the molded product is removed, the processing returns to the same state as in FIG. 6. Therefore, the molding cycle repeats FIGS. 6 to 10 (S24 to S28).

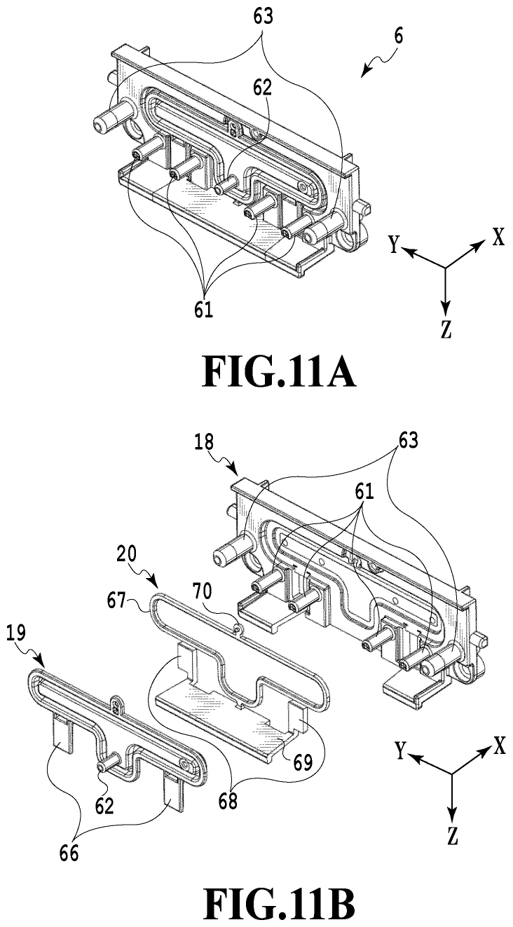

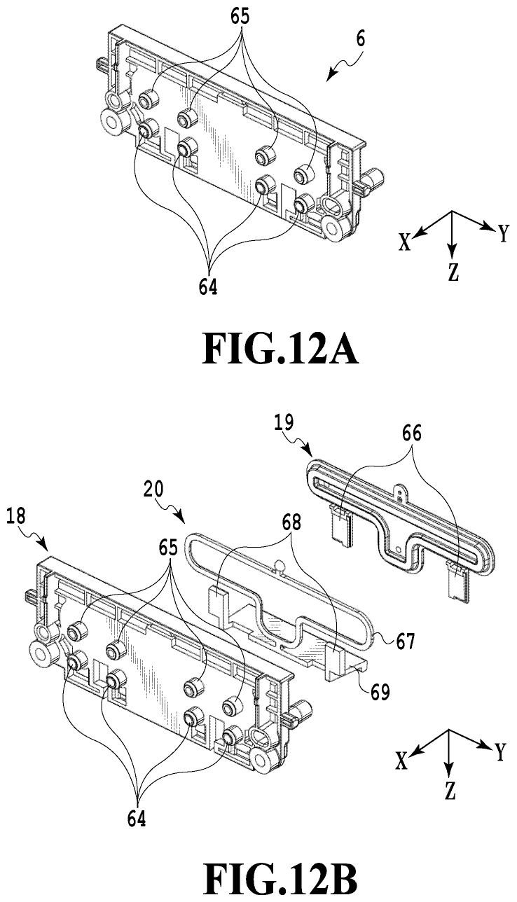

FIGS. 11A, 11B, 12A and 12B are respectively a perspective view of the joint member 6 and an exploded perspective view of the primary molded parts and the bonding resin. FIGS. 11A and 11B, and FIGS. 12A and 12B are respectively views from different viewpoints. For convenience, the viewpoint of FIGS. 11A and 11B will be referred to as the front viewpoint, and the viewpoint of FIGS. 12A and 12B will be referred to as the back viewpoint. With reference to FIGS. 11A, 11B, 12A and 12B, the shape of each part of the joint member 6 will be described below. The primary molded part A (18) and the primary molded part B (19) are both components of the joint member 6, which is the channel forming member.

The primary molded part A (18) has positioning bosses 63 at both ends on the front side for positioning with the apparatus main body unit. The apparatus main body unit has positioning holes (not shown) that mate with these positioning bosses 63. The primary molded part A (18) also has four ink supply paths. Specifically, in the primary molded part A (18), the main body side ink connection needles 61 for connecting to the apparatus main body unit and sub-tank side ink connection needles 64 for connecting to the sub-tank unit 5 penetrate straight from the front to the back. The primary molded part A (18) also has four sub-tank side air connection needles 65 on the back side. The sub-tank side air connection needles 65 are configured to connect to the air channel in the sub-tank unit 5.

The primary molded part B (19) has one main body side air connection needle 62 on the front side for connecting to the apparatus main body unit. The air channel portion is carved into the back side of the primary molded part B (19). This portion (channel groove) is covered by abutting the primary molded part A (18), and the melt resin is poured around the portion for bonding (secondary molding), thereby forming the air channel of the finished product (joint member 6). The above-described four sub-tank side air connection needles 65, the main body side air connection needle 62, and the channel space created by secondary molding constitute an air channel connecting the sub-tank unit 5 and the main body unit. The primary molded part B (19) also includes a cover 66 configured to conceal an excess thickness portion 68 of the bonding resin to be described later.

Next, the shape of the bonding resin 20 (hereinafter also referred to as the bonding resin shape) will be described. The bonding resin shape is formed by filling a bonding resin channel formed by the primary molded parts A (18) and B (19) and the molds with melt resin. For the sake of explanation, in this embodiment, a region of the bonding resin shape that serves to bond the primary molded parts A and B will be referred to as a bonding portion 67. Furthermore, a region of the bonding resin shape for absorbing variations in filling amount of the bonding resin 20 will be referred to as the excess thickness portion 68, and a region of the bonding resin shape that serves to increase the volume will be referred to as a thickened portion 69. Note that the bonding resin 20 of this embodiment is filled through a gate 70.

The bonding portion 67 is formed to seal the periphery of the air channel described above. Due to the bonding characteristics, the bonding portion 67 is characterized by contacting with both of the primary molded parts A (18) and B (19).

Next, the excess thickness portion 68 will be described. The excess thickness portion 68 is provided to absorb variations in filling amount of the bonding resin. Filling too much bonding resin deforms the walls of the primary molded parts, which form the bonding resin channel with weaker strength than the molds, resulting in resin leakage. Once the resin leakage occurs, the bonding resin may clog the channel space, potentially inhibiting the functions of the parts. On the other hand, setting the filling amount of bonding resin too low may cause short-circuiting of the bonding portion due to insufficient filling amount. Such short-circuiting of the bonding portion causes the channel to be communicated to the outside, again inhibiting the functions of the parts. For this reason, an appropriate filling amount is required for the bonding resin, but the filling amount varies. Therefore, the excess thickness portion 68 is provided to absorb the variation in the filling amount. The excess thickness portion 68 is provided in a location to be filled after completion of filling in necessary functional portions such as the bonding portion 67 and the thickened portion 69 to be described below.

Since the excess thickness portion 68 serves to absorb variations in filling, it is uncertain how much of the space provided as the excess thickness portion is actually filled with the bonding resin. In other words, the space provided as the excess thickness portion may be partly or entirely filled with the bonding resin. If only part of the excess thickness portion is filled with the bonding resin, the excess thickness portion 68 may appear to be short-circuited. The above-described Document 1 describes a method for removing the excess thickness portion in post-processing. Furthermore, Document 2 describes a method for integrally molding the excess thickness portion into the exterior surface of the primary molded part to eliminate such post-processing. In the joint member 6 of this embodiment, as in Document 2, the filling space (resin pool) of the excess thickness portion, which does not require post-processing, is formed by the primary molded parts A (18) and B (19) and the molds.

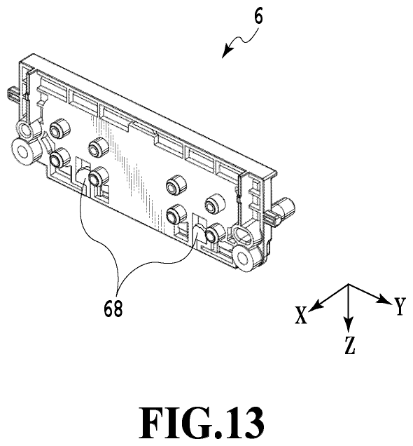

FIG. 13 is a perspective view of the joint member 6 having an excess thickness portion 68 with a different filling amount of bonding resin from the excess thickness portion 68 shown in FIG. 12A, due to filling variations. As shown in FIG. 13, filling variations can result in the formation of the excess thickness portion 68 that appears to be short-circuited. In the print head 1 of this embodiment, such an excess thickness portion 68 is hidden by the cover 66 of the primary molded part B (19) described above, to conceal it from a user. This allows for the arrangement of the excess thickness portion 68 such that the excess thickness portion 68 is visible to the manufacturer from the sub-tank unit 5 side (back side, corresponding to the viewpoints of FIGS. 12 and 13) upon completion of molding, and is not visible to the user after head assembly since the excess thickness portion 68 is hidden inside the head.

The excess thickness portion 68 may have a shape such that the cross-sectional area of the bonding channel is narrowed to momentarily delay the inflow (that is, filling pressure is applied to the bonding portion 67 and the thickened portion 69) so that the necessary functional portion is completely filled before flowing into the resin pool. In other words, a narrowed portion with a smaller cross-sectional area than the upstream portion may be provided, and the excess thickness portion 68 may be formed downstream of the narrowed portion. The narrowed portion can also be considered a connecting portion for connecting the excess thickness portion 68 and the thickened portion 69. Furthermore, the cross-sectional area may be increased to reduce resin leakage due to loss of filling pressure into the excess thickness portion 68 after the inflow into the resin pool. That is, the cross-sectional area of the bonding channel immediately after the inflow into the resin pool may be larger than the cross-sectional area of the bonding channel immediately before the inflow into the resin pool. Therefore, the excess thickness portion 68 of this embodiment also corresponds to the region from the expanded cross-sectional area of the bonding resin channel to the final filling portion of the bonding resin. After passing through the narrowed portion, the bonding resin is filled in part or all of the resin pool, thereby forming the excess thickness portion 68.

Next, the thickened portion 69, which is one of the features of this embodiment, will be described. The thickened portion 69 is a region of the bonding resin shape that does not correspond to either the bonding portion 67 or the excess thickness portion 68. The thickened portion 69 is characterized by abutting only one of the primary molded parts, or by not abutting any of the primary molded parts. Specifically, the bonding channel of the thickened portion 69 is formed by the molds and a single primary molded part, or by the molds alone. The thickened portion 69 is formed by filling such a bonding channel with the bonding resin. The thickened portion 69 of this embodiment is integrated with the primary molded part A (18) to have a shape that forms a single wall as shown in FIGS. 11A and 11B. That is, this wall is where a part of the surface of the thickened portion 69 formed by the molds and a part of the surface of the primary molded part A (18) form the same surface. This wall functions to avoid leaked ink from dripping into unintended locations upon insertion and removal of the apparatus main body unit and the main body side ink connection needle 61 of the joint member 6 or upon irregular ink leakage from the ink channel connection portion. As shown in FIGS. 11A and 11B, this wall has an eave shape. Note that this wall is supposed to be a portion that may be formed only by the primary molded part A (18). However, in this embodiment, by forming a part of the wall with the bonding resin, the insufficient volume of the bonding resin described at the beginning of this embodiment is resolved without increasing the volume of the parts.

One of the features of this embodiment is that the shape of a functional primary molded part is replaced with a certain volume of bonding resin. Furthermore, the bonding interface with the primary molded part is made compatible by replacing the shape with the bonding resin, and a completely integrated shape can be formed by re-hardening. In other words, at least some of the surfaces of the primary molded part A (18) and the thickened portion 69, other than the interface therebetween can be said to form the same surface. This makes it possible to form a functional part with the same strength as the functional part (wall) composed solely of the primary molded part. In this respect, the bonding resin can also be said to be suitable for shape replacement. For example, if a single wall is formed by combining the primary molded parts, gaps or steps are inevitably generated by part tolerance or deformation.

The relationship between the volumes of each part in the bonding resin shape will be described. If the volume of the bonding resin shape exceeds 90% of the lower limit of the recommended injection capacity of the molding machine, for example, production using that molding machine may be selected even if molding stability is somewhat lacking. On the other hand, if the volume of the bonding resin shape is, for example, less than 70% of the lower limit of the recommended injection capacity of the molding machine, it may be considered difficult to perform molding using that molding machine due to a significant lack of stability. For this reason, to increase the molding machine options for the bonding resin with the bonding portion of approximately 60 to 70% of the lower limit of the recommended injection capacity of the molding machine, the volume of the thickened portion 69 may be more than or equal to 50% of the volume of the bonding portion 67. Furthermore, the excess thickness portion 68 may account for more than or equal to 10% of the total volume of the bonding resin, so as to be able to absorb filling volume variations of approximately ±5%. In this case, variation tolerance of more than or equal to ±5% can be expected, including the amount of resin compression after full filling.

The connecting portion between the bonding portion 67 and the thickened portion 69 is provided at the position where the melt resin filled through the gate 70 branches and then converges. This allows the filling pressure inside the bonding resin channel to be transmitted in a balanced manner. Moreover, the resin in the weld portion, which is disadvantageous in achieving high bonding strength, can be extruded into the thickened portion 69, thereby further increasing the bonding strength.

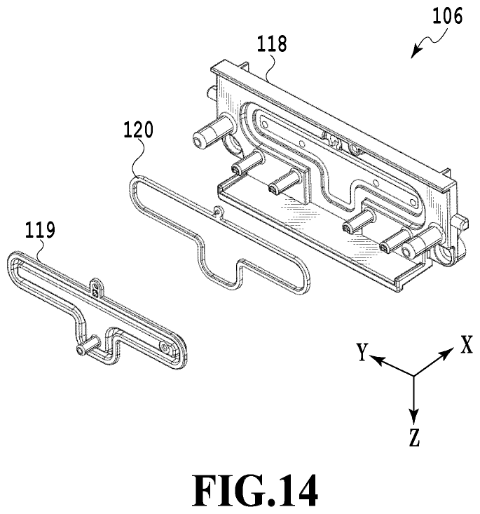

FIG. 14 is a diagram showing a joint member 106 as a comparative example that does not conform to this embodiment. As with FIG. 11B, FIG. 14 is an exploded perspective view of the joint member viewed from the front. FIG. 14 shows an example of a joint member shape in which the bonding resin shape is limited to the minimum necessary bonding portion. In the case of the shape shown in FIG. 14, a bonding resin 120 has a volume of about 250 mm³. A primary molded part A (118) has a volume of about 7800 mm³. A primary molded part B (119) has a volume of about 1250 mm³. As such, the joint member 106 of the comparative example shown in FIG. 14 has a large difference in volume between the bonding resin and the primary molded parts. In this case, it is difficult to select a molding machine capable of accommodating DSI/DRI molds, which tend to become large and heavy due to their die slide/die rotary mechanisms, while keeping the volume of each part within the recommended injection capacity. Furthermore, molding a small-volume bonding resin below the lower limit of the recommended injection capacity has a possibility of making it difficult to ensure stable production.

On the other hand, as described in this embodiment, adopting the bonding resin shape shown in FIGS. 11A and 11B allows the volume of each part to be as follows. The bonding resin 20 has a volume of about 1200 mm³ (bonding portion: 250 mm³, thickened portion: 800 mm³, excess thickness portion: 150 mm³). The primary molded part A (18) has a volume of 6850 mm³. The primary molded part B (19) has a volume of 1450 mm³. As such, compared to the comparative example, the volume of the bonding resin can be increased and the volume difference between the parts can be reduced. This makes it possible to increase the options for the molding machine to be used and to improve the production stability.

Note that the positioning bosses 63 and the main body side ink connection needles 61 of the primary molded part A (18) and the main body side air connection needle 62 of the primary molded part B (19) are held by the separate parts A (18) and B (19) at the time of primary molding. However, in this embodiment, DSI molding or DRI molding is performed, allowing the relative positional accuracy to be maintained at the same level as that of the primary molded parts.

### Second Embodiment

In a second embodiment, a joint member as a channel forming member with a different shape from that of the first embodiment will be described. The basic configuration of the print head and the manufacturing method (molding method) of the joint member are the same as those described in the first embodiment. The following description focuses on differences from the first embodiment. In this embodiment, an example will be described where the filling amount of connecting resin corresponding to a thickened portion is smaller than in the first embodiment.

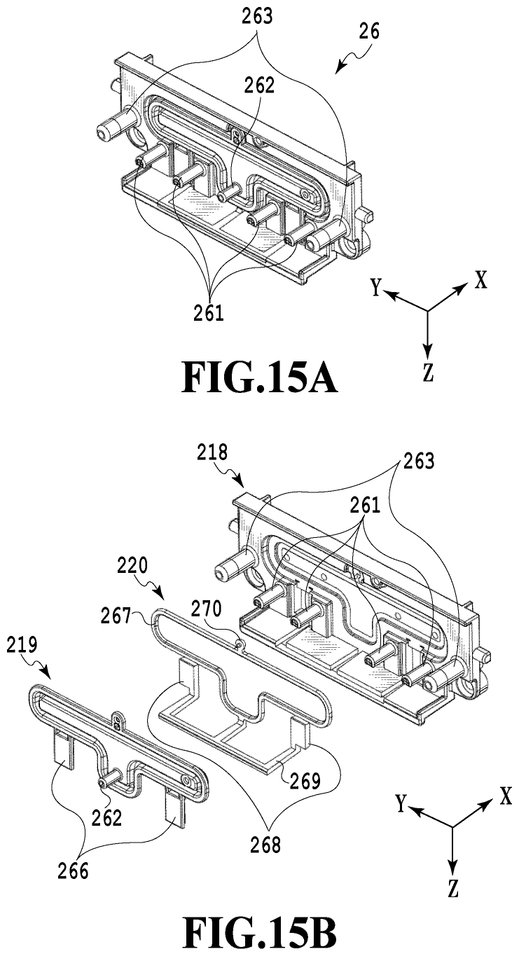

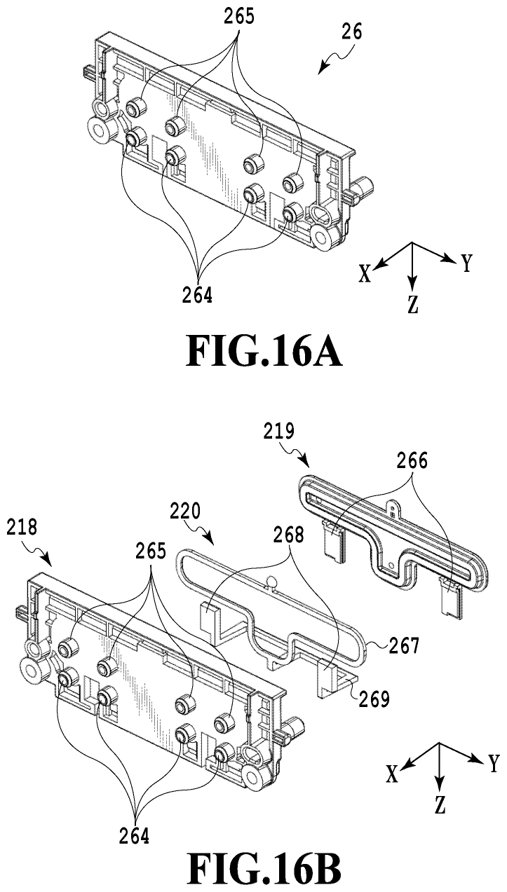

FIGS. 15A, 15B, 16A, and 16B are respectively a perspective view of a joint member 26 in the second embodiment and an exploded perspective view of primary molded parts and the bonding resin. FIGS. 15A and 15B, and FIGS. 16A and 16B are respectively views from different viewpoints. As with FIGS. 11A and 11B, FIGS. 15A and 15B are respectively a perspective view of the joint member 26 viewed from the front. As with FIGS. 12A and 12B, FIGS. 16A and 16B are respectively a perspective view of the joint member 26 viewed from the back. With reference to FIGS. 15A, 15B, 16A, and 16B, the shape of each part of the joint member 26 will be described below.

A primary molded part A (218) has positioning bosses 263 at both ends on the front side for positioning with an apparatus main body unit. The apparatus main body unit has positioning holes (not shown) that mate with these positioning bosses 263. The primary molded part A (218) also has four ink supply paths. Specifically, in the primary molded part A (218), main body side ink connection needles 261 for connecting to the apparatus main body unit and sub-tank side ink connection needles 264 for connecting to a sub-tank unit 5 penetrate straight from the front to the back. The primary molded part A (218) also has four sub-tank side air connection needles 265 on the back side. The sub-tank side air connection needles 265 are configured to connect to an air channel in the sub-tank unit 5.

A primary molded part B (219) has one main body side air connection needle 262 on the front side for connecting to the apparatus main body unit. A portion to be an air channel is carved into the back side of the primary molded part B (219). This portion (channel groove) is covered by abutting the primary molded part A (218), and the melt resin is poured around the portion for bonding (secondary molding), thereby forming the air channel of a finished product (joint member 26). The above-described four sub-tank side air connection needles 265, the main body side air connection needle 262, and the channel space created by secondary molding constitute the air channel connecting the sub-tank unit 5 and the main body unit. The primary molded part B (219) also includes a cover 266 configured to conceal an excess thickness portion 268 of bonding resin to be described later.

Next, a shape of a bonding resin 220 (bonding resin shape) will be described. The bonding resin shape is formed by filling a bonding resin channel formed by the primary molded parts A (218) and B (219) and the molds with melt resin. For the sake of explanation, in this embodiment, a region of the bonding resin shape that serves to bond the primary molded parts A and B will be referred to as a bonding portion 267. Furthermore, a region of the bonding resin shape for absorbing variations in filling amount of the bonding resin 220 will be referred to as an excess thickness portion 268, and a region of the bonding resin shape that serves to increase the volume will be referred to as a thickened portion 269. Note that the bonding resin 220 of this embodiment is filled through a gate 270.

The bonding portion 267 is formed to seal the periphery of the air channel described above. Due to the bonding characteristics, the bonding portion 267 is characterized by contacting with both of the primary molded parts A (218) and B (219).

Next, the excess thickness portion 268 will be described. The excess thickness portion 268 is provided to absorb variations in filling amount of the bonding resin. The excess thickness portion 268 has the same function as that of the excess thickness portion 68 described in the first embodiment, and thus detailed description thereof will be omitted. The excess thickness portion 268 of this embodiment is also provided in a location to be filled after completion of filling in necessary functional portions such as the bonding portion 267 and the thickened portion 269 to be described below.

Since the excess thickness portion 268 also serves to absorb variations in filling, it is uncertain how much of the space provided as the excess thickness portion is actually filled with the bonding resin. This means that the excess thickness portion 268 may appear to be short-circuited. In the joint member 26 of this embodiment, as in the example described in the first embodiment, the filling space (resin pool) of the excess thickness portion, which does not require post-processing, is formed by the primary molded parts A (218) and B (219) and the molds.

In this embodiment, again, filling variations can result in the formation of the excess thickness portion 268 that appears to be short-circuited. In the print head 1 of this embodiment, such an excess thickness portion 268 is hidden by the cover 266 of the primary molded part B (219) described above, to conceal it from a user who uses the product. This allows for the arrangement of the excess thickness portion 268 such that the excess thickness portion 268 is visible to the manufacturer from the sub-tank unit 5 side (back side, corresponding to the viewpoint of FIGS. 16A and 16B) upon completion of molding, and is not visible to the user after head assembly since the excess thickness portion 268 is hidden inside the head.

The excess thickness portion 268 of this embodiment also corresponds to the region from the expanded cross-sectional area of the bonding resin channel to the final filling portion of the bonding resin.

Next, the thickened portion 269, which is one of the features of this embodiment, will be described. The thickened portion 269 of this embodiment is also a region of the bonding resin shape that does not correspond to either the bonding portion 267 or the excess thickness portion 268. The thickened portion 269 is characterized by abutting only one of the primary molded parts. Specifically, the bonding channel of the thickened portion 269 is formed by the molds and a single primary molded part. To be more specific, the thickened portion 269 only abuts the primary molded part A (218). The thickened portion 269 of this embodiment is integrated with the primary molded part A (218) to have a shape that forms a single wall as shown in FIGS. 15A and 15B. This wall functions to avoid leaked ink from dripping into unintended locations upon insertion and removal of the apparatus main body unit and the main body side ink connection needle 261 of the joint member 26 or upon irregular ink leakage from the ink channel connection portion. As shown in FIGS. 15A and 15B, this integrated wall has an eave shape. Note that this wall is supposed to be a portion that may be formed only by the primary molded part A (218). However, in this embodiment, by forming a part of the wall with the bonding resin, insufficient volume of the bonding resin is resolved without increasing the volume of the parts.

As described above, one of the features of this embodiment is that the shape of a functional primary molded part is replaced with a certain volume of bonding resin. Furthermore, the bonding interface with the primary molded part is made compatible by replacing the shape with the bonding resin, and a completely integrated shape can be formed by re-hardening. This makes it possible to form a functional part with the same strength as the functional part (wall) composed solely of the primary molded part. In this respect, the bonding resin can also be said to be suitable for shape replacement. For example, if a single wall is formed by combining the primary molded parts, gaps or steps are inevitably generated by part tolerance or deformation.

The relationship between the volumes of each part in the bonding resin shape will be described. In this embodiment, as described in the first embodiment, the volume of the thickened portion 269 may be more than or equal to 50% of the volume of the bonding portion 267. Furthermore, the excess thickness portion 268 may account for more than or equal to 10% of the volume of the bonding resin, so as to be able to absorb filling volume variations of about ±5%. In this case, variation tolerance of more than or equal to ±5% can be expected, including the amount of resin compression after full filling.

The connecting portion between the bonding portion 267 and the thickened portion 269 is provided at the position where the melt resin filled through the gate 270 branches and then converges. This allows the filling pressure inside the bonding resin channel to be transmitted in a balanced manner. Moreover, the resin in the weld portion, which is disadvantageous in achieving high bonding strength, can be extruded into the thickened portion 269, thereby further increasing the bonding strength.

FIG. 14 described in the first embodiment is the diagram showing the joint member 106 as the comparative example that does not conform to this embodiment. FIG. 14 is also used as a comparative example in this embodiment. As with FIG. 15B, FIG. 14 is an exploded perspective view of the joint member viewed from the front. FIG. 14 shows an example of a joint member shape in which the bonding resin shape is limited to the minimum necessary bonding portion. In the case of the shape shown in FIG. 14, the bonding resin 120 has the volume of about 250 mm³. The primary molded part A (118) has the volume of about 7800 mm³. The primary molded part B (119) has the volume of about 1250 mm³.

On the other hand, as described in this embodiment, adopting the bonding resin shape shown in FIGS. 15A and 15B allows the volume of each part to be as follows. The bonding resin 220 has a volume of about 600 mm³ (bonding portion: 250 mm³, thickened portion: 200 mm³, excess thickness portion: 150 mm³). The primary molded part A (218) has a volume of 7450 mm³. The primary molded part B (219) has a volume of 1450 mm³. As such, compared to the comparative example, the thickened portion 269 and the excess thickness portion 268 can increase the volume of the bonding resin and reduce the volume difference between the parts. This makes it possible to increase the options for the molding machine to be used and to improve the production stability.

Note that the positioning bosses 263 and the main body side ink connection needles 261 of the primary molded part A (218) and the main body side air connection needle 262 of the primary molded part B (219) are held by the separate parts A (218) and B (219) at the time of primary molding. However, in this embodiment, DSI molding or DRI molding is performed, allowing the relative positional accuracy to be maintained as high as that of the primary molded parts.

### Third Embodiment

In the first and second embodiments, the description is given of the example where the bonding resin shape consists of the bonding portion, the thickened portion, and the excess thickness portion in this order from the gate. That is, the description is given of the example where the bonding resin gate is provided in the bonding portion, the connecting portion is provided between the bonding portion and the thickened portion, and the connecting portion is provided between the thickened portion and the excess thickness portion. In this embodiment, an example is described where a bonding resin shape consists of a thickened portion, a bonding portion, and an excess thickness portion in this order from a gate. In other words, an example is described where a bonding resin gate is provided in the thickened portion, a connecting portion is provided between the thickened portion and the bonding portion, and a connecting portion is provided between the bonding portion and the excess thickness portion.

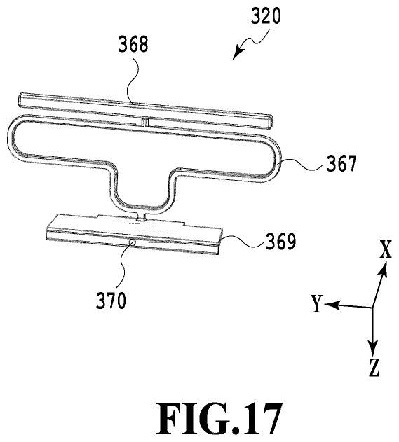

FIG. 17 is a diagram showing an example of a bonding resin 320 in this embodiment. To simplify the explanation, only the bonding resin 320 is described in this embodiment. A region that serves to bond the primary molded parts A and B will be referred to as a bonding portion 367. A region for absorbing variations in filling amount of the bonding resin will be referred to as an excess thickness portion 368. A region that serves to increase the volume will be referred to as a thickened portion 369. The bonding resin 320 of this embodiment is filled through a gate 370.

The bonding portion 367 is a portion formed to seal the periphery of an air channel. The excess thickness portion 368 is provided to absorb variations in the filling amount. As described in the first embodiment and the like, the excess thickness portion 368 is provided in a location to be filled after completion of filling necessary functional portions such as the bonding portion 367 and the thickened portion 369. In this embodiment, the bonding resin starts to be filled first in the thickened portion 369 through the gate 370, and then branches off from the point where the bonding portion 367 is completely filled, thereby forming the shape of the excess thickness portion 368.

As with the example described in the first embodiment, the thickened portion 369 is integrated with the primary molded part A to have a shape that forms a single wall. This shape addresses the lack of bonding resin volume without increasing the volume of the parts.

The connecting portion between the bonding portion 367 and the excess thickness portion 368 is provided at the position where the melt resin filled through the gate 370 converges. This allows the filling pressure inside the bonding resin channel to be transmitted in a balanced manner. Moreover, the resin in the weld portion, which is disadvantageous in achieving high bonding strength, can be extruded into the excess thickness portion 368, thereby further increasing the bonding strength.

### Fourth Embodiment

In the first to third embodiments, the description is given of the example where the thickened portion abuts only one of the primary molded parts. In this embodiment, an example is described where the thickened portion does not abut the primary molded part.

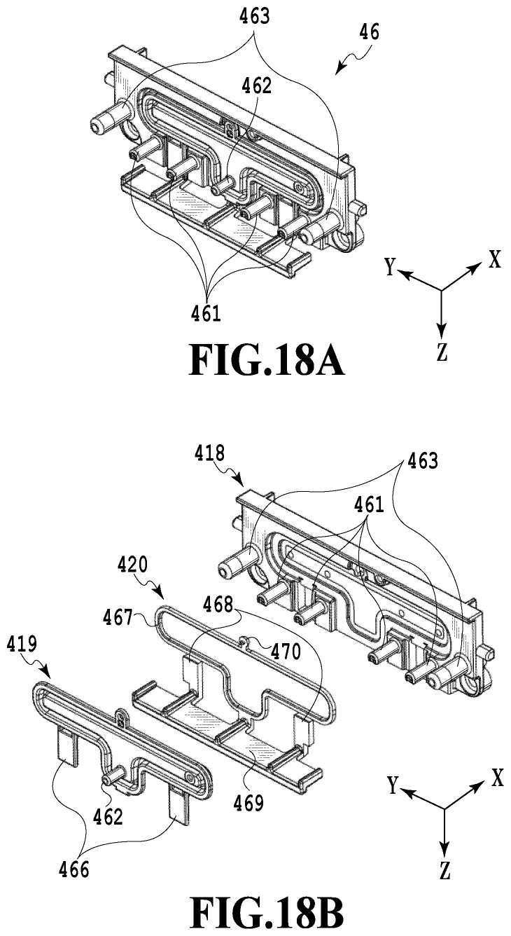

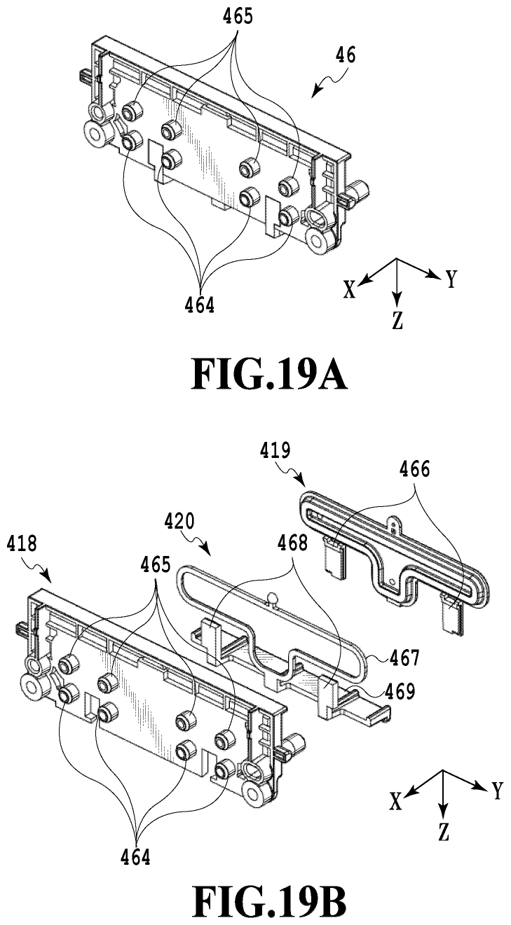

FIGS. 18A, 18B, 19A, and 19B are respectively a perspective view of a joint member 46 in the fourth embodiment and an exploded perspective view of primary molded parts and a bonding resin. FIGS. 18A and 18B, and FIGS. 19A and 19B are respectively views from different viewpoints. As with FIGS. 11A and 11B, FIGS. 18A and 18B are respectively a perspective view of the joint member 46 viewed from the front. As with FIGS. 12A and 12B, FIGS. 19A and 19B are respectively a perspective view of the joint member 46 viewed from the back. With reference to FIG. 18A. 18B, 19A, and 19B, the shape of each part of the joint member 46 will be described below.

A primary molded part A (418) has positioning bosses 463 at both ends on the front side for positioning with an apparatus main body unit. The apparatus main body unit has positioning holes (not shown) that mate with these positioning bosses 463. The primary molded part A (418) also has four ink supply paths. Specifically, in the primary molded part A (418), main body side ink connection needles 461 for connecting to the apparatus main body unit and sub-tank side ink connection needles 464 for connecting to a sub-tank unit 5 penetrate straight from the front to the back. The primary molded part A (418) also has four sub-tank side air connection needles 465 on the back side. The sub-tank side air connection needles 465 are configured to connect to an air channel in the sub-tank unit 5.

A primary molded part B (419) has one main body side air connection needle 462 on the front side for connecting to the apparatus main body unit. A portion to be an air channel is carved into the back side of the primary molded part B (419). This portion (channel groove) is covered by abutting the primary molded part A (418), and the melt resin is poured around the portion for bonding (secondary molding), thereby forming the air channel of a finished product (joint member 46). The above-described four sub-tank side air connection needles 465, the main body side air connection needle 462, and the channel space created by secondary molding constitute the air channel connecting the sub-tank unit 5 and the apparatus main body unit. The primary molded part B (419) also includes a cover 466 configured to conceal an excess thickness portion 468 of bonding resin to be described later.

Next, a shape of a bonding resin 420 (bonding resin shape) will be described. The bonding resin shape is formed by filling a bonding resin channel formed by the primary molded parts A (418) and B (419) and the molds with melt resin. For the sake of explanation, in this embodiment, a region of the bonding resin shape that serves to bond the primary molded parts A and B will be referred to as a bonding portion 467. Furthermore, a region of the bonding resin shape for absorbing variations in filling amount of the bonding resin 420 will be referred to as the excess thickness portion 468, and a region of the bonding resin shape that serves to increase the volume will be referred to as a thickened portion 469. Note that the bonding resin 420 of this embodiment is filled through a gate 470.

The bonding portion 467 is formed to seal the periphery of the air channel described above. Due to the bonding characteristics, the bonding portion 467 is characterized by contacting with both of the primary molded parts A (418) and B (419).

Next, the excess thickness portion 468 will be described. The excess thickness portion 468 is provided to absorb variations in filling amount of the bonding resin. The excess thickness portion 468 has the same function as that of the excess thickness portion 68 described in the first embodiment, and thus detailed description thereof will be omitted. The excess thickness portion 468 of this embodiment is also provided in a location to be filled after completion of filling in necessary functional portions such as the bonding portion 467 and the thickened portion 469 to be described below.

Since the excess thickness portion 468 also serves to absorb variations in filling, it is uncertain how much of the space provided as the excess thickness portion is actually filled with the bonding resin. This means that the excess thickness portion 468 may appear to be short-circuited. In the joint member 46 of this embodiment, as in the example described in the first embodiment, the filling space (resin pool) of the excess thickness portion, which does not require post-processing, is formed by the primary molded parts A (418) and B (419) and the molds.

In this embodiment, again, filling variations can result in the formation of the excess thickness portion 468 that appears to be short-circuited. In the print head 1 of this embodiment, such an excess thickness portion 468 is hidden by the cover 466 of the primary molded part B (419) described above, to conceal it from a user who uses the product. This allows for the arrangement of the excess thickness portion 468 such that the excess thickness portion 468 is visible to the manufacturer from the sub-tank unit 5 side (back side, corresponding to the viewpoint of FIGS. 19A and 19B) upon completion of molding, and is not visible to the user after head assembly since the excess thickness portion 468 is hidden inside the head.

The excess thickness portion 468 of this embodiment also corresponds to the region from the expanded cross-sectional area of the bonding resin channel to the final filling portion of the bonding resin.

Next, the thickened portion 469, which is one of the features of this embodiment, will be described. The thickened portion 469 of this embodiment is also a region of the bonding resin shape that does not correspond to either the bonding portion 467 or the excess thickness portion 468. The thickened portion 469 of this embodiment is characterized by not abutting the primary molded parts. Specifically, the bonding channel of the thickened portion 469 is formed by the molds alone. A wall formed by the thickened portion 469 has a function to avoid leaked ink from dripping into unintended locations upon insertion and removal of the apparatus main body unit and the main body side ink connection needle 461 of the joint member 46 or upon irregular ink leakage from the ink channel connection portion. As shown in FIGS. 18A and 18B, this wall formed by the thickened portion 469 has an eave shape. Note that this wall is supposed to be a portion that may be formed only by the primary molded part A (418) or the primary molded part B (419). However, in this embodiment, by forming this functional part (eave-shaped wall) with the bonding resin, insufficient volume of the bonding resin is resolved without increasing the volume of the parts.

As described above, one of the features of this embodiment is that the shape of a functional primary molded part is replaced with a certain volume of bonding resin.

The relationship between the volumes of each part in the bonding resin shape will be described. In this embodiment, as described in the first embodiment, the volume of the thickened portion 469 may be more than or equal to 50% of the volume of the bonding portion 467. Furthermore, the excess thickness portion 468 may account for more than or equal to 10% of the volume of the bonding resin, so as to be able to absorb filling volume variations of about ±5%. In this case, variation tolerance of more than or equal to ±5% can be expected, including the amount of resin compression after full filling.

The connecting portion between the bonding portion 467 and the thickened portion 469 is provided at the position where the melt resin filled through the gate 470 branches and then converges. This allows the filling pressure inside the bonding resin channel to be transmitted in a balanced manner. Moreover, the resin in the weld portion, which is disadvantageous in achieving high bonding strength, can be extruded into the thickened portion 469, thereby further increasing the bonding strength.

FIG. 14 described in the first embodiment is the diagram showing the joint member 106 as the comparative example that does not conform to this embodiment. FIG. 14 is also used as a comparative example in this embodiment. As with FIG. 18B, FIG. 14 is an exploded perspective view of the joint member viewed from the front. FIG. 14 shows an example of a joint member shape in which the bonding resin shape is limited to the minimum necessary bonding portion. In the case of the shape shown in FIG. 14, the bonding resin 120 has the volume of about 250 mm³. The primary molded part A (118) has the volume of about 7800 mm³. The primary molded part B (119) has the volume of 1250 mm³.

On the other hand, as described in this embodiment, adopting the bonding resin shape shown in FIGS. 18A and 18B allows the volume of each part to be as follows. The bonding resin 420 has a volume of about 1500 mm³ (bonding portion: 250 mm³, thickened portion: 1100 mm³, excess thickness portion: 150 mm³). The primary molded part A (418) has a volume of 6150 mm³. The primary molded part B (419) has a volume of 1450 mm³. As such, compared to the comparative example, the thickened portion 469 and the excess thickness portion 468 can increase the volume of the bonding resin and reduce the volume difference between the parts. This makes it possible to increase the options for the molding machine to be used and to improve the production stability.

Note that the positioning bosses 463 and the main body side ink connection needles 461 of the primary molded part A (418) and the main body side air connection needle 462 of the primary molded part B (419) are held by the separate parts A (418) and B (419) at the time of primary molding. However, in this embodiment, DSI molding or DRI molding is performed, allowing the relative positional accuracy to be maintained as high as that of the primary molded parts.

### Other Embodiments

The above-described embodiments are merely examples and are not limited to the example of molding liquid ejection head parts as described above. The above-described embodiments can be widely applied to parts that form a hollow space by DRI molding or DSI molding.

While the present disclosure has been described with reference to the embodiments, it is to be understood that the present disclosure is not limited to the disclosed embodiments. The scope of the following claims is to be accorded the broadest interpretation so as to encompass all such modifications and equivalent structures and functions.

The present disclosure makes it possible to increase options for the molding machine.

This application claims the benefit of Japanese Patent Application No. 2024-212542, filed Dec. 5, 2024, which is hereby incorporated by reference herein in its entirety.

What is claimed is:

1. A method for manufacturing a channel forming member in which a fluid channel is formed between a first constituent part and a second constituent part, comprising:
injection-molding the first constituent part at a first position between a pair of molds and injection-molding the second constituent part at a second position between the pair of molds;
opening the pair of molds so that the first constituent part remains in one of the pair of molds and the second constituent part remains in the other of the pair of molds, and then moving the pair of molds relative to each other so that the first constituent part and the second constituent part face each other;
closing the pair of molds so that the first constituent part and the second constituent part abut each other; and
pouring melt resin around an abutting portion between the first constituent part and the second constituent part, wherein
in the pouring melt resin, the melt resin forms a bonding portion and a thickened portion,
the bonding portion abuts the first constituent part and the second constituent part,
the thickened portion abuts only one of the first constituent part and the second constituent part, or abuts neither the first constituent part nor the second constituent part, and
a volume of the thickened portion is more than or equal to 50% of a volume of the bonding portion.

2. The method for manufacturing a channel forming member according to claim 1, wherein
in the closing the pair of molds, a bonding channel through which the melt resin flows corresponding to the thickened portion is formed by the molds and the first constituent part,
in the pouring melt resin, the thickened portion is formed by filling the bonding channel with the melt resin, and
a portion of a surface of the thickened portion formed by the molds and a portion of a surface of the first constituent part form the same surface.

3. The method for manufacturing a channel forming member according to claim 1, wherein
in the closing the pair of molds, the first constituent part, the second constituent part, and the molds, the first constituent part and the molds, or the second constituent part and the molds form a resin pool in a bonding channel through which the melt resin flows,
in the pouring melt resin, an excess thickness portion is formed in part or all of the resin pool by filling the bonding channel with the melt resin, and
a cross-sectional area of the bonding channel immediately after inflow into the resin pool is larger than a cross-sectional area of the bonding channel immediately before inflow into the resin pool.

4. The method for manufacturing a channel forming member according to claim 1, wherein
in the closing the pair of molds, the first constituent part, the second constituent part, and the molds, the first constituent part and the molds, or the second constituent part and the molds form a resin pool and a narrowed portion having a smaller channel cross-sectional area than an upstream portion in a bonding channel through which the melt resin flows, and
in the pouring melt resin, the melt resin passes through the narrowed portion and then fills part or all of the resin pool to form an excess thickness portion.

5. The method for manufacturing a channel forming member according to claim 3, wherein
in the pouring melt resin, the melt resin injected through a gate fills the bonding portion, the thickened portion, and the excess thickness portion in this order.

6. The method for manufacturing a channel forming member according to claim 3, wherein
in the pouring melt resin, the melt resin injected through a gate fills the thickened portion, the bonding portion, and the excess thickness portion in this order.

7. The method for manufacturing a channel forming member according to claim 3, wherein
in the closing the pair of molds, a volume of the resin pool formed is more than or equal to 10% of a total volume of the melt resin.

8. A channel forming member having a first constituent part, a second constituent part, and a bonding resin shape formed with bonding resin in a space where the first constituent part and the second constituent part abut each other, and having the first constituent part, the second constituent part, and the bonding resin shape integrated together, wherein
the first constituent part and the second constituent part form a fluid channel,
the bonding resin shape includes
a bonding portion abutting both the first constituent part and the second constituent part, and
a thickened portion abutting only one of the first constituent part and the second constituent part, or abutting neither the first constituent part nor the second constituent part, and
a volume of the thickened portion is more than or equal to 50% of a volume of the bonding portion.

9. The channel forming member according to claim 8, wherein at least a portion of surfaces of the first constituent part and the thickened portion other than an interface form the same surface.

10. The channel forming member according to claim 8, wherein the bonding resin shape includes an excess thickness portion in contact with the first constituent part or the second constituent part.

11. The channel forming member according to claim 10, wherein
a gate of the bonding resin is provided in the bonding portion,
a connecting portion is provided between the bonding portion and the thickened portion, and
a connecting portion is provided between the thickened portion and the excess thickness portion.

12. The channel forming member according to claim 10, wherein
a gate of the bonding resin is provided in the thickened portion,
a connecting portion is provided between the thickened portion and the bonding portion, and
a connecting portion is provided between the bonding portion and the excess thickness portion.

13. The channel forming member according to claim 11, wherein a cross-sectional area of the excess thickness portion is larger than a cross-sectional area of the connecting portion with the thickened portion or a cross-sectional area of the connecting portion with the bonding portion.

14. The channel forming member according to claim 10, wherein a volume of the excess thickness portion is more than or equal to 10% of a volume of the bonding resin shape.
